(19) United States
(12) Patent Application Publication
(10) Pub. No.: US 2023/0327600 A1
(43) Pub. Date: Oct. 12, 2023

(54) ENERGY STORAGE AND GENERATION DEVICE

(71) Applicants: Shun-Tsung LU, Taichung City (TW); Ta-Wei LU, Taichung City (TW)

(72) Inventor: Shun-Tsung LU, Taichung City (TW)

(73) Assignees: Shun-Tsung LU, Taichung City (TW); Ta-Wei LU, Taichung City (TW)

(21) Appl. No.: 17/718,592

(22) Filed: Apr. 12, 2022

(51) Int. Cl. H02S 10/20; H02S 10/40; H02S 30/10; H02S 20/30; F16H 7/02; F16H 51/00

(52) U.S. Cl. CPC H02S 10/20; H02S 10/40; F16H 51/00; H02S 20/30; F16H 7/02; H02S 30/10

(57) ABSTRACT

An energy storage and generation device has a motor, at least one renewable energy generator, a generator configured to be driven by the motor, a first storage unit, and a second storage unit. The first storage unit is for storing electrical energy generated by the generator, and the second storage unit is electrically connected between the at least one renewable energy generator and the motor.

### BACKGROUND OF THE INVENTION

### 1. Field of the Invention

The present invention relates to a generating apparatus, and more particular to an energy storage and generation device for small-scale generation.

### 2. Description of Related Art

Microgeneration is small-scale generation operated by individuals, small enterprises, and communities to satisfy their own needs, so as to reduce reliance on collective electrical grids. Microgeneration is also eco-friendly.

Conventional renewable generating apparatuses mostly transfer energy from water, wind, and the sun to electricity. However, hydroelectric power, wind power, and solar power are all unstable and uncontrollable. For example, at nights or on cloudy days, the conventional renewable generating apparatus that uses solar power cannot generate electricity due to absence of sunshine. Therefore, the conventional renewable generating apparatus has the problems of poor stability and incapability of providing continuous electricity, failing to meet individuals', small enterprises', and communities' needs.

### SUMMARY OF THE INVENTION

The main objective of the present invention is to solve the problems of poor stability and incapability of providing continuous electricity of the conventional renewable generating apparatuses. For individuals, small enterprises, and communities to satisfy their own needs, the present invention provides an energy storage and generation device.

The energy storage and generation device has a motor, at least one renewable energy generator, a generator configured to be driven by the motor, a first storage unit, and a second storage unit. The first storage unit is for storing electrical energy generated by the generator, and the second storage unit is electrically connected between the at least one renewable energy generator and the motor.

Other objectives, advantages and novel features of the invention will become more apparent from the following detailed description when taken in conjunction with the accompanying drawings.

### BRIEF DESCRIPTION OF THE DRAWINGS

FIG. 1 is a schematic chart depicting energy flow of a first embodiment of an energy storage and generation device in accordance with the present invention;

FIG. 2 is an operational block diagram of the energy storage and generation device in FIG. 1;

FIG. 3 is a perspective view of the energy storage and generation device in FIG. 1;

FIG. 4 is an operational perspective view of the energy storage and generation device in FIG. 1;

FIG. 5 is a top view of the energy storage and generation device in FIG. 4;

FIG. 6 is a cross-sectional side view of the energy storage and generation device in FIG. 1;

FIG. 7 is a cross-sectional side view of the energy storage and generation device across line 7-7 depicted in FIG. 6;

FIG. 8 is an operational view of the energy storage and generation device in FIG. 6; and

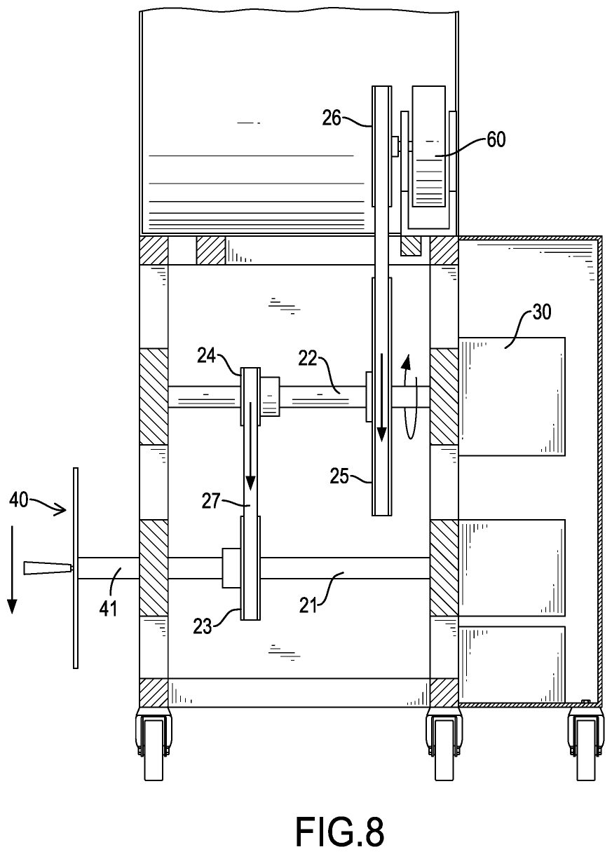

FIG. 9 is a schematic view of a second embodiment of an energy storage and generation device in accordance with the present invention.

### DETAILED DESCRIPTION OF THE PREFERRED EMBODIMENT

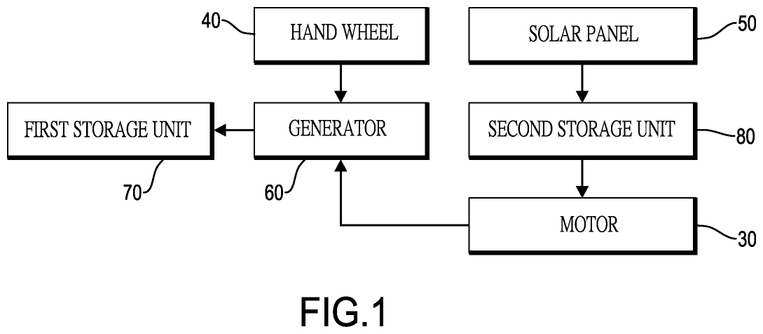

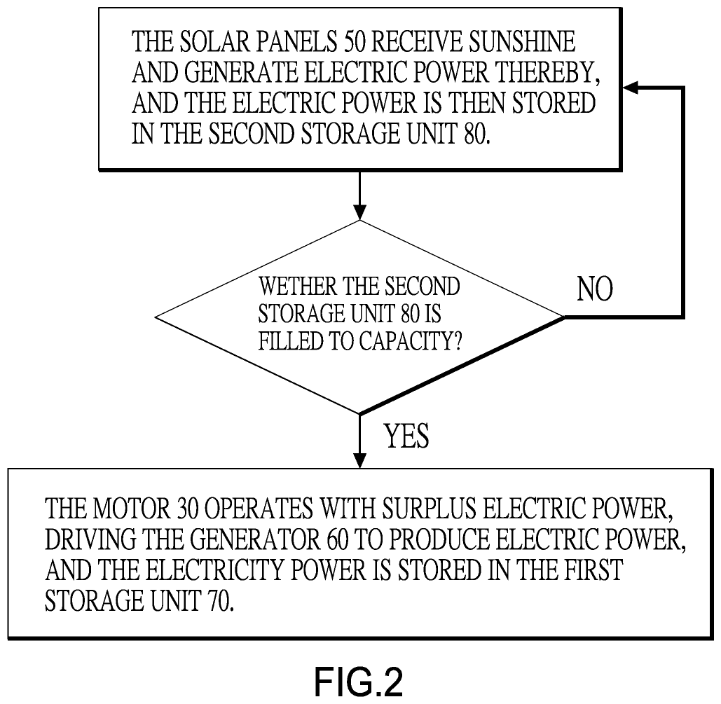

With reference to FIGS. 1 to 4, a first embodiment of an energy storage and generation device in accordance with the present invention comprises a motor 30, at least one renewable energy generator, a generator 60, a first storage unit 70, and a second storage unit 80. The second storage unit 80 is electrically connected with the at least one renewable energy generator for storing electric energy generated by the at least one renewable energy generator. With reference to FIGS. 1 and 2, in the first embodiment of the present invention, the at least one renewable energy generator is at least one solar panel 50. The generator 60 is capable of being driven by the motor 30. The first storage unit 70 is electrically connected with the generator 60 for storing electric energy generated by the generator 60. The second storage unit 80 is electrically connected between the at least one solar panel 50 and the motor 30 for storing the electric energy generated by the at least one solar panel 50 and providing the same to the motor 30, so as to drive the motor 30 to operate. Storage capacity of the first storage unit 70 is larger than that of the second storage unit 80.

With reference to FIGS. 1 and 2, in the first embodiment of the present invention, when the at least one solar panel 50 may receive sunshine, the at least one solar panel 50 receives sunshine and generates electric power thereby, and the electric power is then stored to the second storage unit 80. After the second storage unit 80 is filled to full capacity, the motor 30 may operate with surplus electric power provided by the at least one solar panel 50. The generator 60 is driven by the operation of the motor 30, and generates electric power. The electric power from the generator 60 is then stored to the first storage unit 70. Due to the larger storage capacity of the first storage unit 70, when sunshine exists, the generator 60 is capable of generating electric power constantly via the motor 30 operating with the surplus energy from the second storage unit 80. The electric power generated by the generator 60 is stored in the first storage unit 70. Thus, when a user needs power, sufficient power is ready in the first storage unit 70, serving as a stable power source.

Specifically, with reference to FIGS. 1, 3, 5, and 6, the first embodiment of the energy storage and generation device of the present invention further comprises a mobile frame 10, a transmission 20, and a hand wheel 40.

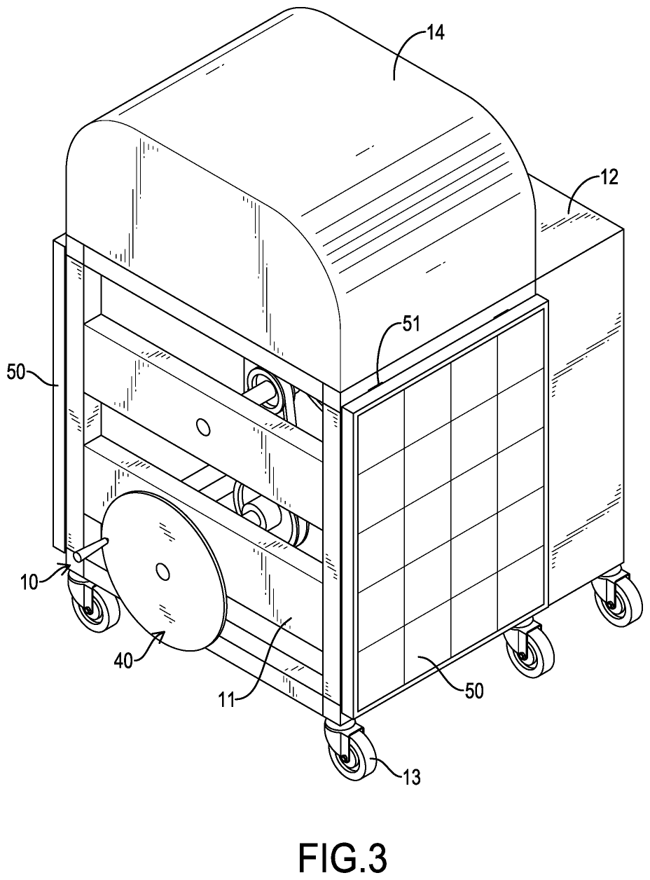

With reference to FIGS. 3 to 6, the mobile frame 10 has a main frame body 11, an auxiliary frame body 12, multiple casters 13, and a cap 14. The auxiliary frame body 12 is connected to a side of the main frame body 11, and interiors of the main frame body 11 and the auxiliary frame body 12 communicate with each other. The auxiliary frame body 12 may be either mounted with the main frame body 11 or fixed to the main frame body 11. The multiple casters 13 are mounted on a bottom of the mobile frame 10. With the multiple casters 13, the mobile frame 10 is moveable relative to a ground. Specifically, in the first embodiment of the present invention, both a bottom of the main frame body 11 and a bottom of the auxiliary frame body 12 are equipped with the casters 13. In other embodiments, only the main frame body 11 or only the auxiliary frame body 12 is equipped with the casters 13. The cap 14 is mounted on a top of the main frame body 11. Preferably, the cap 14 is hinged on a side of the top of the main frame body 11.

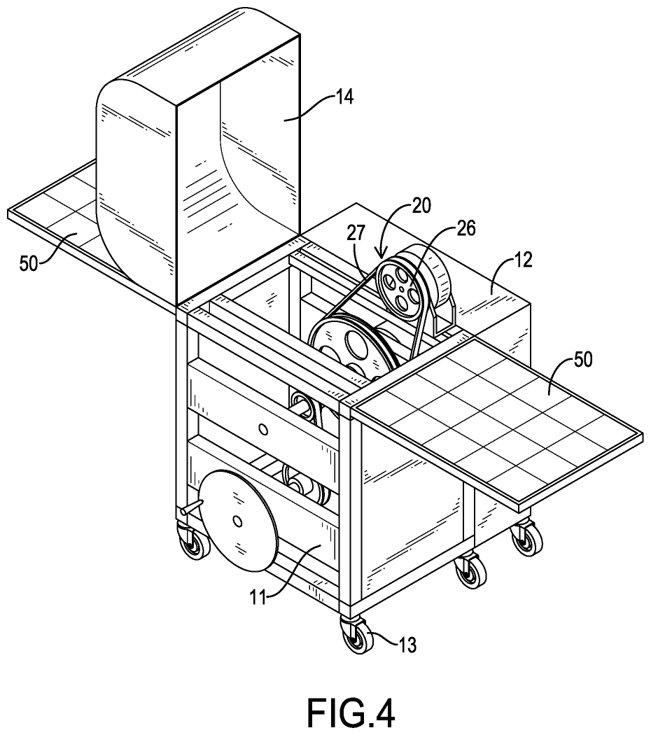

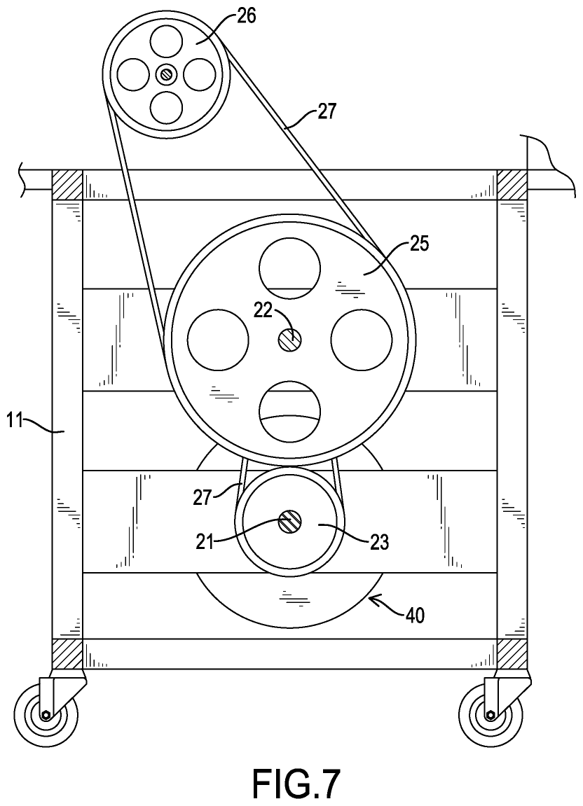

With reference to FIGS. 4 to 7, the transmission 20 is disposed in the mobile frame 10, and is connected to and mounted in the main frame body 11 of the mobile frame 10, and comprises a first transmission shaft 21, a second transmission shaft 22, a first gearing wheel 23, a first driven wheel 24, a second gearing wheel 25, a second driven wheel 26, and two belts 27. Each one of the first transmission shaft 21 and the second transmission shaft 22 is connected to two inner surfaces of the main frame body 11, and the first transmission shaft 21 and the second transmission shaft 22 are located at a spaced interval. The first gearing wheel 23 is located on the first transmission shaft 21. The first driven wheel 24 and the second gearing wheel 25 are located on the second transmission shaft 22 at a spaced interval. The second driven wheel 26 is located on the top of the main frame body 11, is connected to the generator 60, and is configured to drive the generator 60. The two belts 27 are respectively connected between the first gearing wheel 23 and the first driven wheel 24 and between the second gearing wheel and the second driven wheel 26.

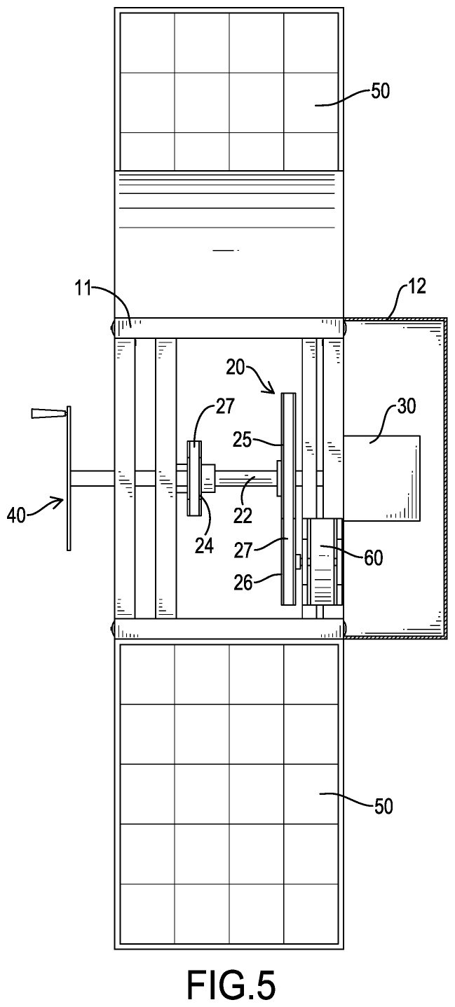

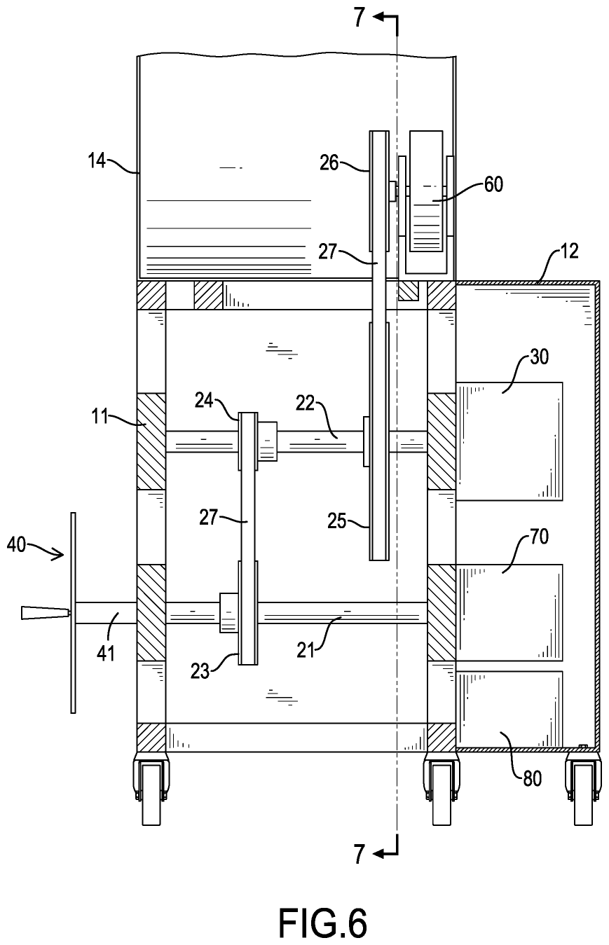

With reference to FIGS. 5 and 6, the motor 30 is located in the auxiliary frame body 12 of the mobile frame 10, and is connected to a side of the main frame body 11. The motor 30 has a driving shaft connected with the second transmission shaft 22 of the transmission 20. Thus, as the motor 30 operates, the driving shaft of the motor 30 leads to rotation of the second transmission shaft 22, and the generator 60 is thereby driven via the second gearing wheel 25, the corresponding belt 27, and the second driven wheel 26. The motor 30 may be adapted to be detachably connected with the main frame body 11. In this way, the motor 30 may provide a driving force to other articles.

With reference to FIGS. 3, 5 and 6, the hand wheel 40 is mounted to an outer surface of the mobile frame 10, and has a transmitting shaft 41 connected with the first transmission shaft 21 of the transmission 20. Moreover, the hand wheel 40 is located on another side of the main frame body 11 opposite to the auxiliary frame body 12 near the bottom of the main frame body 11. With reference to FIG. 6, when the user turns the hand wheel 40, the transmitting shaft 41 of the hand wheel 40 rotates the first transmission shaft 21, and the generator 60 is thereby driven via the first gearing wheel 23, the corresponding belt 27, the first driven wheel 24, and the second transmission shaft 22, and further via the second gearing wheel 25, the corresponding belt 27, and the second driven wheel 26.

With reference to FIGS. 3 to 5, the at least one solar panel 50 is disposed outside the mobile frame 10. Specifically, the at least one solar panel 50 is pivotally connected to another outer surface of the main frame body 11 of the mobile frame 10 instead of the outer surface with the hand wheel 40. Furthermore, said solar panel 50 is connected to the mobile frame 10 near the top thereof via at least one hinge mechanism. Therefore, the at least one solar panel 50 may swing against the mobile frame 10. In the first embodiment of the present invention, the energy storage and generation device comprises two said solar panels 50 located on two different outer surfaces of the main frame body 11 of the mobile frame 10, and the two outer surfaces are different from the outer surface with the hand wheel 40. In this way, operations of the two said solar panels 50 and the hand wheel 40 will not interfere with one another, and spatial efficiency is improved.

With reference to FIGS. 5 and 6, the generator 60 is located on the top of the main frame body 11, and when closed, the cap 14 covers the generator 60. The generator 60 is connected with the second driven wheel 26 of the transmission 20, so the generator 60 can be driven by the hand wheel 40 or the motor 30 via the transmission 20 to start generating electric power under the principle of electromagnetic induction. With reference to FIG. 6, the first storage unit 70 and the second storage unit 80 are located in the auxiliary frame body 12 of the mobile frame 10. In other embodiments, the first storage unit 70 and the second storage unit 80 may be electrically connected to each other.

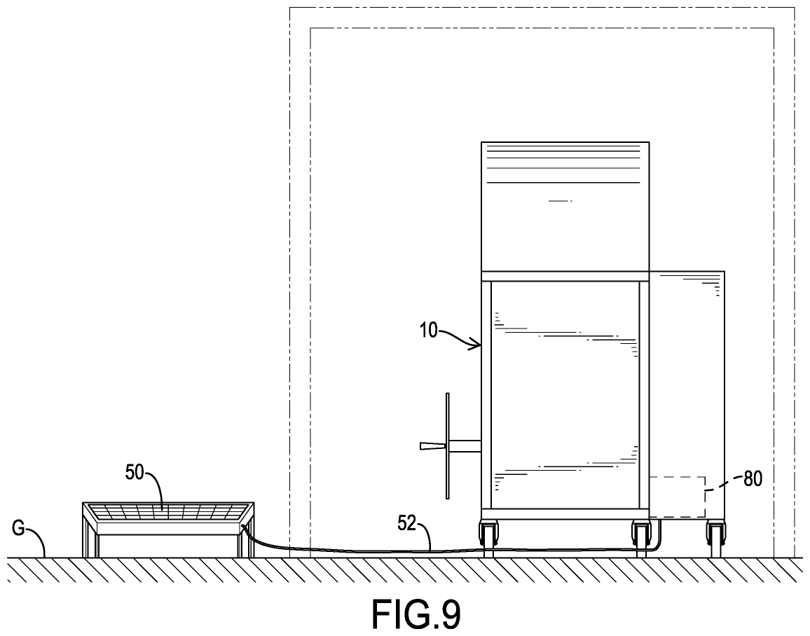

With reference to FIG. 9, a second embodiment of the present invention differs from the first embodiment in that: the at least one solar panel 50 is separated from the mobile frame 10, and is capable of being placed on a ground G and connected with the second storage unit 80 via a cable 52. Thereby the mobile frame 10 may be placed indoors, and the at least one solar panel 50 alone is exposed outdoors on a sunny day. The at least one solar panel 50 can generate electric power in this situation, and the electric power is stored in the second storage unit 80.

Furthermore, adopting multiple said solar panels 50 can increase stored electric power in daytime, and the motor 30 can thereby operate more stably for power generation or other purposes. When said solar panel 50 alone is used for power generation, the output is unstable and unsuitable to serve as a stable power source.

Furthermore, each solar panel 50, the second storage unit 80, and the motor 30 may be electrically connected with a controller. Thereby the controller can switch the power output from each solar panel 50 directly to the motor 30 when the second storage unit 80 is filled to full capacity.

Besides individuals, small enterprises, and communities, users in remote districts or districts where disasters occur frequently can use the energy storage and generation device of the present invention. As long as the energy storage and generation device is prepared, the users can turn the hand wheel 40 for urgent power generation when power is needed. Also, in good weather, said solar panel 50 can be used. When the second storage unit 80 is filled and said solar panel 50 keeps generating power, the electric power can be supplied to the motor 30 to avoid waste. Preferably, the mobile frame 10 can be moved to a suitable spot for power generation and later moved to the place where power supply is needed. The users at the place can take advantage of the electric power stored in the first storage unit 70 and the second storage unit 80.

With the aforementioned technical characteristics, the energy storage and generation device of the present invention provides merits of stable power generation and mitigates the problems of the conventional renewable generating apparatuses.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An energy storage and generation device comprising:
a motor;
at least one renewable energy generator;
a generator configured to be driven by the motor;
a first storage unit for storing electrical energy generated by the generator; and
a second storage unit electrically connected between the at least one renewable energy generator and the motor.

2. The energy storage and generation device as claimed in claim 1, wherein the energy storage and generation device comprises:
a mobile frame having multiple casters mounted on a bottom of the mobile frame;
a transmission disposed in the mobile frame; and
a hand wheel mounted to an outer surface of the mobile frame and having a transmitting shaft connected with the transmission;
wherein the at least one renewable energy generator is at least one solar panel, the motor has a driving shaft connected with the transmission, the at least one solar panel is disposed outside the mobile frame, and the generator is connected with the transmission.

3. The energy storage and generation device as claimed in claim 2, wherein the at least one solar panel is pivotally connected to another outer surface of the mobile frame.

4. The energy storage and generation device as claimed in claim 2, wherein the at least one solar panel is separated from the mobile frame, and is capable of being placed on a ground and connected with the second storage unit via a cable.

5. The energy storage and generation device as claimed in claim 2, wherein
the transmission comprises a first transmission shaft, a second transmission shaft, a first gearing wheel, a first driven wheel, a second gearing wheel, and a second driven wheel;
the first transmission shaft is connected with the transmitting shaft of the hand wheel;
the second transmission shaft is connected with the driving shaft of the motor, and is located at a spaced interval from the first transmission shaft;
the first gearing wheel is located on the first transmission shaft;
the first driven wheel and the second gearing wheel are located on the second transmission shaft at a spaced interval;
the second driven wheel is configured to drive the generator; and
two belts are respectively connected between the first gearing wheel and the first driven wheel and between the second gearing wheel and the second driven wheel.

6. The energy storage and generation device as claimed in claim 3, wherein
the transmission comprises a first transmission shaft, a second transmission shaft, a first gearing wheel, a first driven wheel, a second gearing wheel, and a second driven wheel;
the first transmission shaft is connected with the transmitting shaft of the hand wheel;
the second transmission shaft is connected with the driving shaft of the motor, and is located at a spaced interval from the first transmission shaft;
the first gearing wheel is located on the first transmission shaft;
the first driven wheel and the second gearing wheel are located on the second transmission shaft at a spaced interval;
the second driven wheel is configured to drive the generator; and
two belts are respectively connected between the first gearing wheel and the first driven wheel and between the second gearing wheel and the second driven wheel.

7. The energy storage and generation device as claimed in claim 4, wherein
the transmission comprises a first transmission shaft, a second transmission shaft, a first gearing wheel, a first driven wheel, a second gearing wheel, and a second driven wheel;
the first transmission shaft is connected with the transmitting shaft of the hand wheel;
the second transmission shaft is connected with the driving shaft of the motor, and is located at a spaced interval from the first transmission shaft;
the first gearing wheel is located on the first transmission shaft;
the first driven wheel and the second gearing wheel are located on the second transmission shaft at a spaced interval;
the second driven wheel is configured to drive the generator; and
two belts are respectively connected between the first gearing wheel and the first driven wheel and between the second gearing wheel and the second driven wheel.

8. The energy storage and generation device as claimed in claim 2, wherein
the mobile frame comprises a main frame body and an auxiliary frame body, and interiors of the main frame body and the auxiliary frame body communicate with each other;
the hand wheel is connected to a side of the main frame body;
the auxiliary frame body is connected to another side of the main frame body opposite to the hand wheel;
the transmission is located in the main frame body;
the generator is located on a top of the main frame body; and
the motor, the first storage unit, and the second storage unit are located in the auxiliary frame body.

9. The energy storage and generation device as claimed in claim 3, wherein
the mobile frame comprises a main frame body and an auxiliary frame body, and interiors of the main frame body and the auxiliary frame body communicate with each other;
the hand wheel is connected to a side of the main frame body;
the auxiliary frame body is connected to another side of the main frame body opposite to the hand wheel;
the transmission is located in the main frame body;
the generator is located on a top of the main frame body; and
the motor, the first storage unit, and the second storage unit are located in the auxiliary frame body.

10. The energy storage and generation device as claimed in claim 4, wherein
the mobile frame comprises a main frame body and an auxiliary frame body, and interiors of the main frame body and the auxiliary frame body communicate with each other;
the hand wheel is connected to a side of the main frame body;
the auxiliary frame body is connected to another side of the main frame body opposite to the hand wheel;
the transmission is located in the main frame body;
the generator is located on a top of the main frame body; and
the motor, the first storage unit, and the second storage unit are located in the auxiliary frame body.

11. The energy storage and generation device as claimed in claim 8, wherein the main frame body has a cap on the top, and the cap covers the generator.

12. The energy storage and generation device as claimed in claim 9, wherein the main frame body has a cap on the top, and the cap covers the generator.

13. The energy storage and generation device as claimed in claim 10, wherein the main frame body has a cap on the top, and the cap covers the generator.

14. The energy storage and generation device as claimed in claim 2, wherein the hand wheel is located near the bottom of the mobile frame.

15. The energy storage and generation device as claimed in claim 3, wherein the hand wheel is located near the bottom of the mobile frame.

16. The energy storage and generation device as claimed in claim 4, wherein the hand wheel is located near the bottom of the mobile frame.

17. The energy storage and generation device as claimed in claim 14, wherein
the energy storage and generation device has two said solar panels located near a top of the mobile frame; and
the two solar panels are respectively located on two different surfaces of the mobile frame, and are electrically connected with the second storage unit.

18. The energy storage and generation device as claimed in claim 15, wherein
the energy storage and generation device has two said solar panels located near a top of the mobile frame; and
the two solar panels are respectively located on two different surfaces of the mobile frame, and are electrically connected with the second storage unit.

19. The energy storage and generation device as claimed in claim 16, wherein
the energy storage and generation device has two said solar panels located near a top of the mobile frame; and
the two solar panels are respectively located on two different surfaces of the mobile frame, and are electrically connected with the second storage unit.

20. The energy storage and generation device as claimed in claim 1, wherein the first storage unit has a larger storage capacity than the second storage unit.
